(19) United States
(12) Patent Application Publication
(10) Pub. No.: US 2012/0108291 A1
(43) Pub. Date: May 3, 2012

(54) IMAGE PICKUP APPARATUS AND MOBILE PHONE EQUIPPED THEREWITH

(75) Inventor: Katsushi Sumisaki, Osaka (JP)

(73) Assignee: PANASONIC CORPORATION, Osaka (JP)

(21) Appl. No.: 13/380,958

(22) PCT Filed: Jul. 1, 2010
(86) PCT No.: PCT/JP2010/004333

§ 371 Date: Dec. 27, 2011

(30) Foreign Application Priority Data
Jul. 2, 2009 (JP) 2009-157604

(51) Int. Cl. H04W 88/02; H04N 5/225

(52) U.S. Cl. 455/556.1; 348/370; 348/E05.024

(57) ABSTRACT

An image pickup apparatus includes light-emitting means for emitting light to a person as a subject when the subject is photographed, and light emission control means for controlling the amount of light emitted by the light-emitting means. The light emission control means increases the amount of light gradually (either continuously or intermittently) until it reaches a predetermined amount, based on the detection result of the light detection means for detecting light from the subject. The image pickup apparatus can limit the glare of the light emitted by the light-emitting means, thereby projecting the eyes of the subject, and allowing the subject to be properly photographed.

### TECHNICAL FIELD

The present invention relates to an image pickup apparatus mounted on a mobile phone, a digital camera, or other similar device, and also relates to a mobile phone equipped with the apparatus.

### BACKGROUND ART

Conventional image pickup apparatuses mounted on mobile phones, digital cameras, and other similar devices generally include an image pickup device for photographing a subject, and light-emitting means for emitting light to the subject. When the image pickup device photographs a subject, the amount of light emitted to the subject by the light-emitting means is determined according to the photographic environment.

Exposed to the amount of light determined according to the photographic environment, the subject can be photographed without light deficiency problems.

In these image pickup apparatuses, however, when the subject is a human being, the light emitted by the light-emitting means may cause glare that can irritate their eyes. The glare of the light can particularly irritate the eyes of the subject when a moving image is photographed because it requires light to be emitted continuously to the subject. Therefore, in these apparatuses, users are allowed to select between photographing a moving image and a still image. In addition, the light-emitting means is controlled to emit light with lower luminance when a moving image is photographed than when a still image is photographed, in the case that the distance to the subject is smaller than a predetermined distance (see, for example, Patent Literature 1).

In these image pickup apparatuses, in the case that the distance to the subject is smaller than the predetermined distance, the light-emitting means is controlled to emit light with lower luminance when a moving image is photographed than when a still image is photographed. With this structure, the light-emitting means emits light with limited glare. In the case that the distance to the subject is not smaller than the predetermined distance, the light-emitting means can emit light with limitless high luminance to a distant subject, thereby providing sufficient illumination.

Eye sensitivity differs from person to person. Even the glare of light with low luminance emitted for a short time may irritate the eyes of some people if the amount of the light is too much at one time.

Therefore, even in the image pickup apparatuses having the above-described structure, the glare of the light emitted by the light-emitting means may irritate the eyes of the subject. Thus, in these image pickup apparatuses, in the case that the distance to the subject is smaller than the predetermined distance, the light-emitting means is controlled to emit light with lower luminance when a moving image is photographed than when a still image is photographed. Even so, the glare of the light may irritate the eyes of the subject because a predetermined amount (specific amount) of light is emitted at one time regardless of whether the subject is photographed as a moving image or a still image.

In the image pickup apparatuses having the above-described structure, the glare of the light emitted by the light-emitting means particularly irritates the eyes of the subject when a still image is photographed because the luminance of the light is higher than when a moving image is photographed.

Consequently, these image pickup apparatuses may cause the subject to close their eyes due to the glare of the light emitted by the light-emitting means. As a result, the subject may be photographed with their eyes closed.

In view of these problems, an object of the present invention is to provide an image pickup apparatus and a mobile phone equipped with this apparatus, which can limit the glare of the light emitted by the light-emitting means, thereby preventing the eyes of the subject from being damaged by the glare and allowing the subject to be properly photographed.

### CITATION LIST

### Patent Literature

Patent Literature 1: Japanese Patent Unexamined Publication No. 2007-49572

### SUMMARY OF THE INVENTION

The image pickup apparatus of the present invention including light-emitting means for emitting a predetermined amount of light to a subject when the subject is photographed also includes light emission control means for controlling the amount of light emitted by the light-emitting means. The light emission control means gradually increases the amount of light until it reaches a predetermined amount.

With this structure, the amount of light emitted to the subject increases gradually. Since the light-emitting means does not emit the predetermined amount of light to the subject at one time, the light does not cause glare that could irritate the eyes of the subject when the subject is a human being. As a result, the eyes of the subject are prevented from being damaged by the glare, and from being closed when the subject is photographed. When photographed, the subject is exposed to the predetermined amount of light, thereby being properly photographed without light deficiency problems.

The image pickup apparatus of the present invention preferably includes light detection means for detecting light from the subject, and the light emission control means preferably controls the amount of light emitted by the light-emitting means based on the detection result of the light detection means. With this structure, the light-emitting means does not emit excessive light to a human being (subject) before the light reaches the predetermined amount, thereby limiting the glare that could irritate the eyes of the subject. Thus, the amount of light emitted to the subject by the light-emitting means is determined according to the conditions, thereby limiting the glare of the light that could irritate the eyes of the subject.

In this case, the image pickup apparatus preferably includes face recognition means for recognizing the position of the face of the subject by processing an image obtained from the light detected by the light detection means. With this structure, it is possible to recognize the face of the subject, thereby ensuring to limit the glare of the light emitted by the light-emitting means. More specifically, the face recognition means recognizes the eye region of the subject, allowing the amount of light emitted to be determined according to the luminance (brightness) of the region. This prevents excessive light from being emitted to the region, thereby ensuring to limit the glare of the light emitted by the light-emitting means.

The light emission control means preferably controls the light-emitting means to emit a predetermined constant amount of light when the light from the subject detected by the light detection means reaches a predetermined amount required for photographing. With this structure, it is possible to prevent the light-emitting means from emitting more light than necessary, thereby preventing unnecessary power consumption.

The light-emitting means is preferably an LED. With this structure, it is easy to control the amount of light emitted by the light-emitting means, and to prevent unnecessary power consumption.

The mobile phone of the present invention is equipped with the image pickup apparatus having one of the above-described structures. In the mobile phone equipped with the image pickup apparatus, the light emitted by the light-emitting means does not cause glare that could irritate the eyes of the subject when the subject is a human being. As a result, the eyes of the subject are prevented from being damaged by the glare, and from being closed when the subject is photographed. When photographed, the subject is exposed to the predetermined amount of light, thereby being properly photographed without light deficiency problems.

As described hereinbefore, according to the present invention, it is possible to limit the glare of the light emitted by the light-emitting means, thereby preventing the eyes of the subject from being damaged by the glare and allowing the subject to be properly photographed.

### BRIEF DESCRIPTION OF DRAWINGS

FIG. 1 is a block diagram of an image pickup apparatus according to an embodiment of the present invention.

FIG. 2 is a graph showing a light emitting state of light-emitting means of the image pickup apparatus according to the embodiment.

FIG. 3A is a front view of a mobile phone equipped with the image pickup apparatus according to the embodiment.

FIG. 3B is a rear view of the mobile phone equipped with the image pickup apparatus according to the embodiment.

FIG. 4 is a flowchart showing an operation procedure of the image pickup apparatus according to the embodiment.

FIG. 5A is a graph showing a light emitting state of the light-emitting means of an image pickup apparatus according to another embodiment of the present invention when the amount of light emitted is increased gradually at a constant rate until it reaches a predetermined amount.

FIG. 5B is a graph showing a light emitting state of the light-emitting means of an image pickup apparatus according to further another embodiment when the amount of light emitted is increased gradually at a variable rate until it reaches the predetermined amount.

FIG. 5C is a graph showing a light emitting state of the light-emitting means of the image pickup apparatus according to further another embodiment when the amount of light emitted is increased like a quadratic curve until it reaches the predetermined amount.

FIG. 5D is a graph showing a light emitting state of the light-emitting means of the image pickup apparatus according to further another embodiment when the amount of light emitted is increased like a cubic curve until it reaches the predetermined amount.

FIG. 5E is a graph showing a light emitting state of the light-emitting means of the image pickup apparatus according to further another embodiment when the amount of light emitted is increased intermittently at every predetermined time interval until it reaches the predetermined amount.

FIG. 5F is a graph showing a light emitting state of the light-emitting means of the image pickup apparatus according to further another embodiment when the amount of light emitted is increased intermittently for different periods of time until it reaches the predetermined amount.

### DESCRIPTION OF EMBODIMENTS

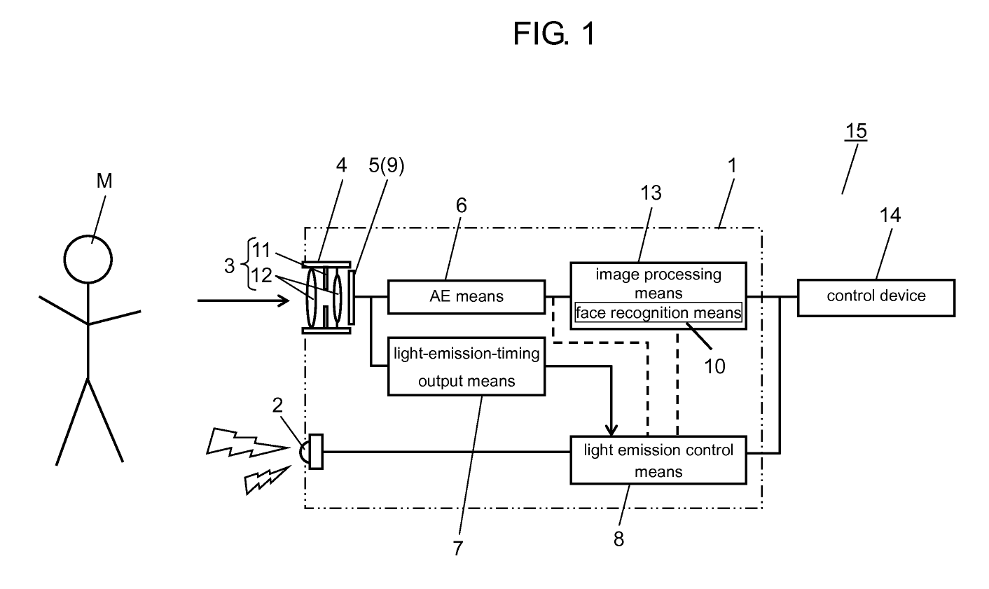

An embodiment of the present invention will be described as follows with reference to the accompanied drawings. FIG. 1 is a block diagram of an image pickup apparatus according to an embodiment of the present invention. Image pickup apparatus 1 of the present embodiment includes light-emitting means 2 for emitting a predetermined amount of light to subject “M” when it is photographed.

More specifically, image pickup apparatus 1 includes lens barrel 4 having optical system 3 inside, image pickup device 5, AE means 6, light-emitting means 2, light-emission-timing output means 7, and light emission control means 8. Image pickup device 5 photographs an image which passes through optical system 3. AE means 6 automatically determines exposure. Light-emitting means 2 emits the predetermined amount of light to subject M when it is photographed. Light-emission-timing output means 7 outputs a light emission timing of light-emitting means 2. Light emission control means 8 controls the amount of the light emitted by light-emitting means 2.

Image pickup apparatus 1 also includes light detection means 9 for detecting light from subject M. Image pickup apparatus 1 also includes face recognition means 10 for recognizing the position of the face of subject M by processing an image obtained from the light detected by light detection means 9 on the assumption that light detection means 9 is provided.

Optical system 3 provided inside lens barrel 4 includes diaphragm mechanism 11, and one or more lenses 12.

Image pickup device 5 can be a photodiode or a CMOS (a solid image pickup device such as a CCD), both of which can pickup the light from subject M as an image. In the present embodiment, image pickup device 5 is a CMOS. Image pickup device 5 is disposed such that its center coincides with the optical axis of optical system 3 (lens 12).

AE means 6 is composed of a control board (not shown) including a CPU and a RAM. Through an internal process, AE means 6 calculates a luminance value from the light (image) detected by image pickup device 5, and automatically determines the exposure (a combination of the F value and the shutter speed) based on the luminance value.

Light-emission-timing output means 7, which is composed of a control board (not shown) including a CPU and a RAM, is configured to output a signal to light emission control means 8. The signal controls light-emitting means 2 to emit light according to the timing at which image pickup device 5 photographs a subject.

Light-emitting means 2 emits light under the control of light emission control means 8 based on the signal from light-emission-timing output means 7. Light-emitting means 2 can be a flash discharge tube, but is an LED in the present embodiment.

Light emission control means 8 is composed of a control board (not shown) including a CPU and a RAM. Light emission control means 8 receives the luminance value calculated by AE means 6 and the signal from light-emission-timing output means 7. Then, light emission control means 8 controls light-emitting means 2 to emit light based on the received input.

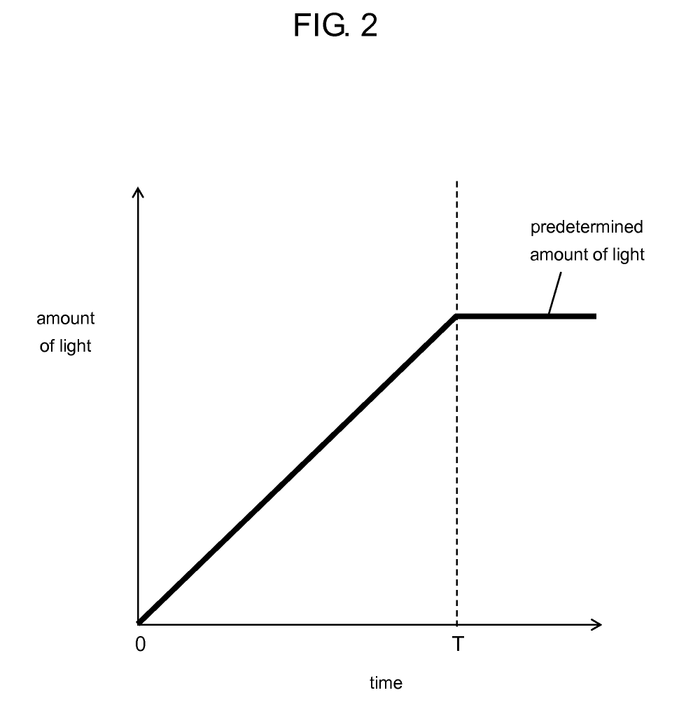

Light emission control means 8 is configured to gradually increase the amount of light emitted by light-emitting means 2 until it reaches a predetermined amount as shown in FIG. 2. More specifically, light emission control means 8 is configured to gradually increase the amount of light emitted by light-emitting means 2 from zero to the predetermined amount continuously within a predetermined time T (such as two or three seconds) before image pickup device 5 photographs subject M. As a result, image pickup device 5 can photograph subject M with an amount of light determined according to the photographic environment. More specifically, light emission control means 8 of the present embodiment is configured to increase the amount of light emitted by light-emitting means 2 both continuously and proportionally with time within the predetermined time T.

Light emission control means 8 of the present embodiment is configured to control the amount of light emitted by light-emitting means 2 based on the detection result of light detection means 9. More specifically, light emission control means 8 finds the present brightness of subject M, and controls light-emitting means 2 to emit the amount of light according to the brightness within the predetermined time T before image pickup device 5 photographs subject M. Light emission control means 8 then controls light-emitting means 2 based on the light from subject M detected by light detection means 9. Thus, in the present embodiment, light emission control means 8 controls the amount of light emitted by light-emitting means 2 based on the luminance value obtained from the detection result of light detection means 9.

Referring back to FIG. 1, light detection means 9 can be a photodiode or a CMOS (a solid image pickup device such as a CCD). In the present embodiment, light detection means 9 is a CMOS. In image pickup apparatus 1 of the present embodiment, image pickup device 5 functions as light detection means 9. It is possible to separately provide image pickup device 5 for photographing subject M, and light detection means 9 for detecting light from subject M. In image pickup apparatus 1 of the present embodiment, however, image pickup device 5, which is configured to be able to obtain light from subject M as an image, also functions as light detection means 9.

In the present embodiment, image pickup device 5 and light detection means 9 are composed of one unit. However, light detection means 9 detects the light before image pickup device 5 photographs subject M (before image pickup device 5 takes in an image of subject M as a still or moving image to a storage medium). In the following description, light detection means 9 is used to perform a process required before taking in and storing the image of subject M as a still or moving image, whereas image pickup device 5 is used to take in the image of subject M as a still or moving image.

Face recognition means 10 is configured to recognize the face of subject M at least before image pickup device 5 photographs subject M (takes in the image), that is, within the predetermined time T before image pickup device 5 photographs subject M.

Image pickup apparatus 1 of the present embodiment also includes image processing means 13 for processing an image obtained from the light detected by light detection means 9. Face recognition means 10 is provided as a component of image processing means 13. Image processing means 13, which is composed of a control board (not shown) including a CPU and a RAM, performs image processing and face recognition through an internal process. In the block diagram of FIG. 1, AE means 6, light-emission-timing output means 7, light emission control means 8, and image processing means 13 are independent of each other. In reality, however, they may be composed of the same control board and perform their processes independently.

There are many face recognition techniques. In the present embodiment, an obtained image is compared with a predetermined facial pattern (for example, a pattern of facial features including eyes, a nose, and a mouth), and a region coinciding or nearly coinciding with the pattern is recognized as a human face.

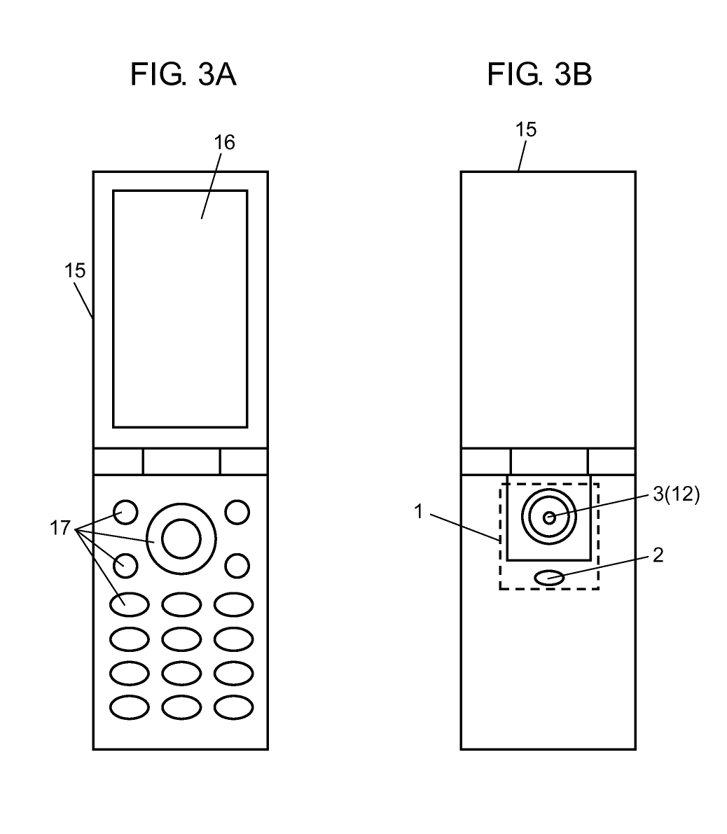

Image pickup apparatus 1 of the present embodiment is mounted on mobile phone 15. Mobile phone 15 mounted on image pickup apparatus 1 includes operation screen 16 and operation buttons 17 at its front as shown in FIG. 3A. The user can talk on the phone or use various functions including the camera (image pickup apparatus 1) by pushing operation buttons 17. As shown in FIG. 3B, mobile phone 15 has image pickup apparatus 1 inside except that light-emitting means 2 and optical system 3 (lens 12) are exposed on the rear surface of it.

As shown in FIG. 1, mobile phone 15 includes control device 14 for controlling the functions of mobile phone 15. Control device 14 is electrically connected to the control boards (such as image processing means 13 and light emission control means 8) of image pickup apparatus 1. The user can make light-emitting means 2 emit light or image pickup device 5 perform photographing by pushing operation buttons 17 of mobile phone 15.

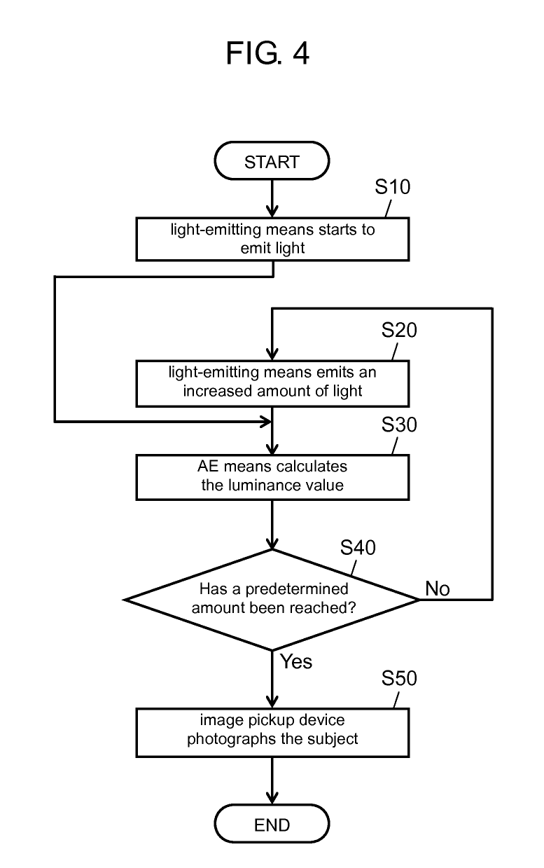

Image pickup apparatus 1 and mobile phone 15 equipped therewith which are structured as above perform the following operations as shown in the flowchart of FIG. 4.

First, the user pushes operation buttons 17 to operate light-emitting means 2 (to be more exact, to make image pickup device 5 perform photographing) with image pickup apparatus 1 (optical system 3) facing subject M. Light emission control means 8 receives a signal from light-emission-timing output means 7, and controls light-emitting means 2 to start to emit light as shown in FIG. 4. In response, light-emitting means 2 starts to emit light (S10).

Light emission control means 8 controls light-emitting means 2 to emit light such that the amount of light gradually increases until it reaches the predetermined amount. In response, light-emitting means 2 emits light such that the amount of light increases proportionally with time from zero.

In the present embodiment, light detection means 9 for detecting the light from subject M as described above detects the light emitted by light-emitting means 2 to subject M (the light reflected from subject M). Then, it is determined whether the amount of light emitted by light-emitting means 2 is properly increasing. If it is determined not to be proper, light emission control means 8 controls light-emitting means 2 to emit a proper amount of light. In the present embodiment, the luminance value of the light detected by light detection means 9 is calculated with time also by AE means 6. Light emission control means 8 finds the condition of the light from subject M based on the luminance value calculated by AE means 6, thereby controlling the amount of light emitted by light-emitting means 2.

In the present embodiment, face recognition means 10 recognizes the face of subject M. Light emission control means 8 finds the condition of the light from subject M based on the luminance value of the region that face recognition means 10 has recognized as the face of subject M. Light emission control means 8 then controls the amount of light emitted by light-emitting means 2. Thus, light emission control means 8 controls the amount of light emitted by light-emitting means 2 so as not to cause glare that could irritate the eyes of subject M.

As described above, AE means 6 calculates the luminance value (S30), and light emission control means 8 determines whether the calculation result (luminance value) of AE means 6 has reached a predetermined amount (an amount required by the photographic environment) (S40). If the luminance value is determined not to have reached the predetermined amount (NO in S40), light emission control means 8 controls light-emitting means 2 to increase the amount of light. In response, light-emitting means 2 emits an increased amount of light (S20).

When light-emitting means 2 emits the increased amount of light, AE means 6 again calculates (measures) the luminance value based on the light from subject M (the light detected by light detection means 9) (S30). If the luminance value is determined not to have reached the predetermined amount (NO in S40), light emission control means 8 controls light-emitting means 2 to increase the amount of light. In response, light-emitting means 2 emits an increased amount of light (S20). As long as the luminance value is determined not to have reached the predetermined amount (NO in S40), light emission control means 8 continues to control light-emitting means 2 to increase the amount of light.

When the calculation result of AE means 6 is determined to have reached the predetermined amount (YES in S40), light emission control means 8 controls light-emitting means 2 to emit a constant amount of light. In response, light-emitting means 2 emits a constant amount of light (a predetermined amount of light). Thus, light emission control means 8 controls light-emitting means 2 to emit the predetermined amount of light until image pickup device 5 finishes photographing, and in response to this, light-emitting means 2 emits the light.

Then, image pickup device 5 performs photographing (S50). When the image is taken in as a still or moving image, the series of operations are completed (END).

As described hereinbefore, image pickup apparatus 1 of the present embodiment includes light emission control means 8 for controlling the amount of light emitted by light-emitting means 2. Since light emission control means 8 is configured to gradually increase the amount of light until it reaches a predetermined amount, the amount of light emitted to subject M gradually increases. Since light-emitting means 2 does not emit the predetermined amount of light to subject M at one time, the light does not cause glare that could irritates the eyes of subject M when subject M is a human being. As a result, the eyes of subject M are prevented from being damaged by the glare, and from being closed when photographed. Furthermore, the gradual increase in the amount of light emitted by light-emitting means 2 allows the eyes of subject M to adapt to the light of light-emitting means 2, thereby reducing red eye. When photographed, subject M is exposed to the predetermined amount of light, thereby being properly photographed without light deficiency problems.

Image pickup apparatus 1 of the present embodiment also includes light detection means 9 for detecting light from subject M. Light emission control means 8 controls the amount of light emitted by light-emitting means 2 based on the detection result of light detection means 9. Therefore, light-emitting means 2 does not emit excessive light to a human being as subject M before the light reaches the predetermined amount, thereby ensuring to limit the glare that could irritate the eyes of the subject.

Image pickup apparatus 1 of the present embodiment also includes face recognition means 10 for recognizing the position of the face of subject M by processing the image obtained from the light detected by light detection means 9. Face recognition means 10 recognizes the eye region of subject M so as to prevent excessive light from being emitted to the region, thereby ensuring to limit the glare of the light emitted by the light-emitting means.

In image pickup apparatus 1 of the present embodiment, when the light from subject M detected by light detection means 9 reaches the predetermined amount required for photographing, light emission control means 8 controls light-emitting means 2 to emit a constant amount of light. As a result, light-emitting means 2 is prevented from emitting more light than necessary, thereby preventing unnecessary power consumption.

In image pickup apparatus 1 of the present embodiment, light-emitting means 2 is an LED. As a result, it is easy to control the amount of light emitted by the light-emitting means, and to prevent unnecessary power consumption.

In mobile phone 15 of the present embodiment equipped with image pickup apparatus 1, the light emitted by light-emitting means 2 does not cause glare that could irritate the eyes of subject M when subject M is a human being. As a result, the eyes of subject M are prevented from being damaged by the glare, and from being closed when photographed. When photographed, subject M is exposed to the predetermined amount of light, thereby being properly photographed without light deficiency problems.

The present invention is not limited to the above-described embodiment, and can be modified within the range of not greatly deviating from the spirit of the present invention.

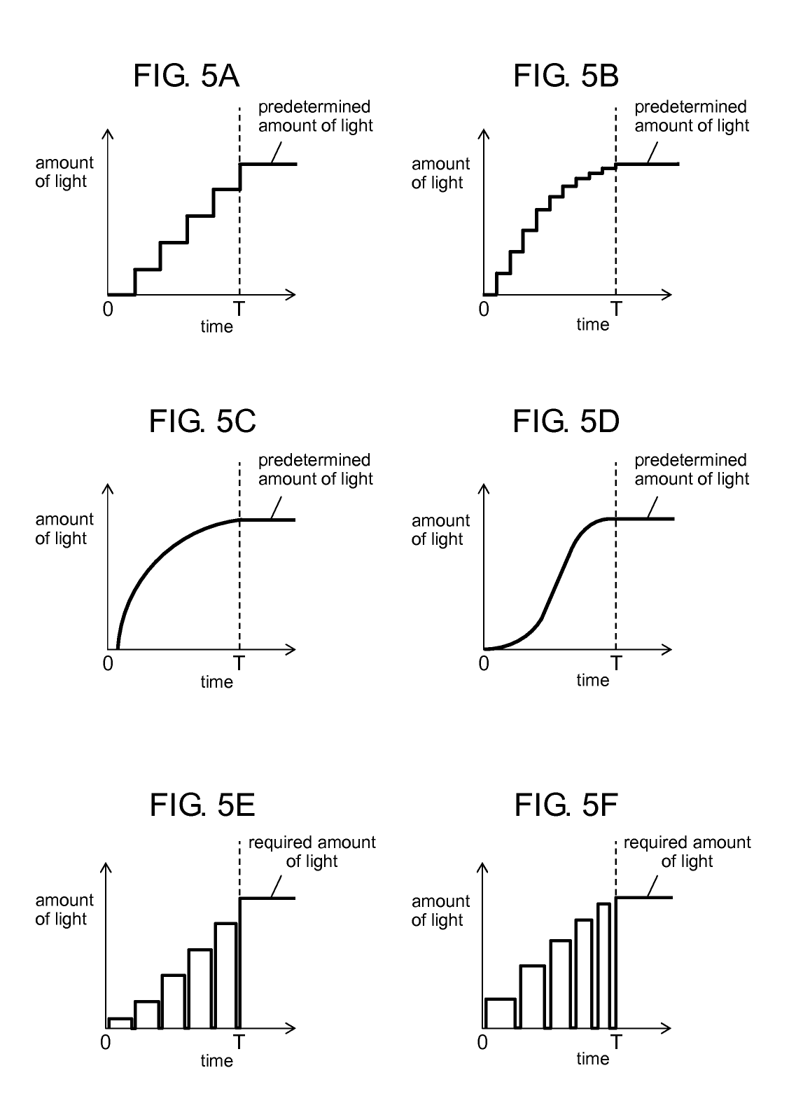

In the above-described embodiment, light emission control means 8 controls light-emitting means 2 to emit light in such a manner as to increase both continuously and proportionally with time until the light reaches the predetermined amount. The way to control the amount of light, however, is not limited to this. For example, light emission control means 8 may control light-emitting means 2 to emit light continuously while gradually increasing its amount as shown in FIGS. 5A and 5B. More specifically, light emission control means 8 may control light-emitting means 2 to emit light continuously, while increasing its amount either at a constant rate at unit time intervals as shown in FIG. 5A, or at a variable rate at unit time intervals as shown in FIG. 5B. Alternatively, light emission control means 8 may control light-emitting means 2 to emit light continuously, while increasing its amount as expressed by a high-order function as shown in FIGS. 5C and 5D. More specifically, light emission control means 8 may control light-emitting means 2 to emit light continuously, while increasing its amount like a quadratic curve with time as shown in FIG. 5C or like a cubic curve with time as shown in FIG. 5D.

Instead of controlling light-emitting means 2 to emit light continuously, while gradually increasing its amount, light emission control means 8 may control light-emitting means 2 to emit light intermittently, while increasing its amount every time light-emitting means 2 emits light as shown in FIGS. 5E and 5F. More specifically, light emission control means 8 may control light-emitting means 2 to emit light intermittently, while increasing its amount every time light-emitting means 2 emits light either at a constant rate as shown in FIG. 5E or at a variable rate as shown in FIG. 5F.

In the above-described embodiment, image pickup apparatus 1 includes face recognition means 10 to control the amount of light emitted by light-emitting means 2 to optimize the luminance (the amount) of light emitted to the face of subject M, but face recognition means 10 is not an essential component. For example, it is possible to find the amount of light (luminance) based on the image obtained from the entire light detected by light detection means 9 instead of providing face recognition means 10. To efficiently reduce the glare that irritates the eyes of subject M, however, it is preferable to provide face recognition means 10 so as to recognize the eye region (the face) which is irritated by the glare and then to control the amount of light emitted by light-emitting means 2.

In the above-described embodiment, light detection means 9 and image pickup device 5 are composed of one unit. Instead of this, it is possible to separately provide image pickup device 5 for taking in an image of subject M, and light detection means 9 for detecting the light from subject M. To minimize image pickup apparatus 1, however, it is preferable to provide light detection means 9 and image pickup device 5 as one unit as in the above-described embodiment.

In the above-described embodiment, the amount of light emitted by light-emitting means 2 is kept constant after it reaches the predetermined amount. Instead of this, it is possible that image pickup device 5 photographs subject M as soon as the amount of light of light-emitting means 2 reaches the predetermined amount, and that light-emitting means 2 finishes emitting light as soon as image pickup device 5 finishes photograph subject M.

In the above-described embodiment, light-emitting means 2 is an LED. Alternatively, light-emitting means 2 can be, for example, flash discharge tube. When a flash discharge tube is used, however, it is impossible to emit light continuously. Therefore, as shown in FIGS. 5E and 5F, light-emitting means 2 (flash discharge tube) can be configured to emit light intermittently, and to increase its amount every time light-emitting means 2 emits light.

In the above-described embodiment, image pickup apparatus 1 is mounted on mobile phone 15, but can alternatively be mounted on a general digital camera or other device.

### INDUSTRIAL APPLICABILITY

The image pickup apparatus of the present invention includes light-emitting means for emitting a predetermined amount of light to subject when it is photographed, and light emission control means for controlling the amount of light emitted by the light-emitting means. This image pickup apparatus is suitable for use to limit the glare of the light emitted by the light-emitting means, thereby preventing the eyes of the subject from being damaged by the glare and allowing the subject to be properly photographed.

### REFERENCE MARKS IN THE DRAWINGS

1 image pickup apparatus
2 light-emitting means
3 optical system
4 lens barrel
5 image pickup device
6 AE means
7 light-emission-timing output means
8 light emission control means
9 light detection means
10 face recognition means
11 diaphragm mechanism
12 lens
13 image processing means
14 control device
15 mobile phone
16 operation screen
17 operation button
M subject (person)

1. An image pickup apparatus comprising:
light-emitting means for emitting light to a subject; and
light emission control means for controlling an amount of light emitted by the light-emitting means, wherein
the light emission control means increases the amount of light emitted by the light-emitting means either continuously or intermittently from zero to a predetermined amount.

2. The image pickup apparatus of claim 1, further comprising:
light detection means for detecting light from the subject, wherein
the light emission control means controls the amount of light emitted by the light-emitting means to reach a predetermined amount based on a detection result of the light detection means.

3. The image pickup apparatus of claim 2, further comprising:
face recognition means for recognizing a position of a face of the subject by processing an image obtained from the light detected by the light detection means, wherein
the light emission control means controls the amount of light emitted by the light-emitting means to reach the predetermined amount based on a luminance value of a region recognized as the face of a person as the subject by the face recognition means.

4. The image pickup apparatus of claim 2, wherein
when the light from the subject detected by the light detection means reaches the predetermined amount required to photograph the subject, the light emission control means keeps the amount of light emitted by the light-emitting means at the predetermined amount.

5. The image pickup apparatus of claim 1, wherein
the light-emitting means is an LED.

6. A mobile phone comprising:
the image pickup apparatus of claim 1.

7. The image pickup apparatus of claim 3, wherein
when the light from the subject detected by the light detection means reaches the predetermined amount required to photograph the subject, the light emission control means keeps the amount of light emitted by the light-emitting means at the predetermined amount.

8. The image pickup apparatus of claim 2, wherein
the light-emitting means is an LED.

9. The image pickup apparatus of claim 3, wherein
the light-emitting means is an LED.

10. A mobile phone comprising:
the image pickup apparatus of claim 2.

11. A mobile phone comprising:
the image pickup apparatus of claim 3.
